(19) United States
(12) Patent Application Publication
(10) Pub. No.: US 2006/0238304 A1
(43) Pub. Date: Oct. 26, 2006

(54) System and method for adapting an FRID tag reader to its environment

(76) Inventor: Sean Loving, Lafayette, CO (US)

Correspondence Address: COOLEY GODWARD LLP;ATTN: PATENT GROUP, THE BOWEN BUILDING, 875 15TH STREET, N.W. SUITE 800, WASHINGTON, DC, 20005-2221, US

(21) Appl. No.: 11/301,587

(22) Filed: Dec. 13, 2005

Related U.S. Application Data
(60) Provisional application No. 60/673,692, filed on Apr. 21, 2005.
(60) Provisional application No. 60/712,957, filed on Aug. 31, 2005.

(51) Int. Cl. H04Q 5/22

(52) U.S. Cl. 340/10.1; 340/10.3

(57) ABSTRACT

Systems and methods for configuring an RFID tag reader based upon one or more aspects of an environment of the RFID tag reader are disclosed. In one embodiment, a tag reader is deployed into an environment that includes at least one readable RFID tags capable of storing dynamic data, and a characteristic of the environment of the tag reader is identified. Based upon the identified characteristic, the configuration of the tag reader is adjusted. In variations, the tag reader is configurable based upon information received from at least one RFID tags.

### RELATED APPLICATIONS

The present application claims benefit of priority to commonly owned and assigned U.S. Provisional Application Nos. 60/673,692, filed 21 Apr. 2005 and 60/712,957, filed 31 Aug. 2005, each of which is incorporated herein by reference.

The present application is related to commonly owned and assigned application Ser. No. 11/301,770, filed Dec. 13, 2005; application Ser. No. 11/301,396, filed Dec. 13, 2005, and application Ser. No. 11/301,423, filed Dec. 13, 2005, each of which is incorporated herein by reference.

### BACKGROUND

1. Field of the Invention

The present invention relates to communications systems, such as RFID systems or other systems for communicating with tag identifiers.

2. Description of the Related Art

Tag identifiers have numerous applications including contactless payments, item tracking, and automatic data collection. The various uses for tag identifier technology continue to increase, and ISO standards have been adopted. One example of a standardized tag identifier technology is Radio-Frequency Identification (RFID). Tag identifier systems have achieved widespread use in a variety of different applications and environments of use. At the present time, one barrier to further development is the difficulty of adapting existing systems for additional functionality, and adapting existing systems for specialized new uses.

As the number of applications rise, so too does the need to embed tag readers in greater numbers of devices and to use readers across an ever-widening range of regulatory, technological, and operating environments. The costs associated with developing specialized, monolithic readers that require custom-manufacturing and configuration for every one of these different environments of use may be prohibitive. Although the present devices are functional, they may not be sufficiently accurate or otherwise satisfactory for certain applications.

### SUMMARY

Accordingly, a system and method are needed to address the shortfalls of present technology and to provide other new and innovative features. The presently disclosed instrumentalities overcome the problems outlined above and advance the art by providing a tag reader system with a configuration that is adjustable on the basis of information received from tag identifiers.

Exemplary embodiments of the present invention that are shown in the drawings are summarized below. These and other embodiments are more fully described in the Detailed Description section. One skilled in the art can recognize that there are numerous modifications, equivalents and alternative constructions that fall within the spirit and scope of the invention as expressed in the claims.

In one embodiment, a method for enhancing tag reading performance includes sending a first signal to at least one of a plurality of tags that are capable of storing dynamic data, receiving information from each of the plurality of tags at a tag reader and adjusting a configuration of a tag reader based upon at least a portion of the received information.

In one aspect, the method for enhancing tag reading performance may include sending a signal to a tag that is capable of storing dynamic data, receiving information from the tag with a tag reader, identifying a characteristic of an environment of the tag reader and adjusting a configuration of the tag reader based upon the characteristic of the environment.

An adaptable RFID tag reader may include a processing portion that is configured to: send a signal to an RFID tag; receive information from the RFID tag; identify a characteristic of an environment of the RFID tag reader, and adjust a configuration of the RFID tag reader, based upon the characteristic of the environment of the RFID tag reader.

In yet another aspect of what is shown, a configurable RFID tag reader may include a processing portion that is configured to send a first signal to each of a plurality of RFID tags, to receive information from at least one or all of the plurality of RFID tags, and to adjust a configuration of the RFID tag reader based upon at least a portion of the received information.

In yet another aspect, a method enhances RFID tag reading performance. An RFID tag reader is deployed into an environment that includes at least one RFID tag. A characteristic of the environment of the RFID tag reader is identified. A configuration of the RFID tag reader is adjusted based upon the characteristic of the environment. A signal is sent to the at least one RFID tag and information is received from the at least one RFID tag.

As previously stated, the above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 is a block diagram depicting an exemplary environment that may be experienced by a tag reader;

FIG. 2 is a block diagram depicting one embodiment of the tag reader of FIG. 1.

FIG. 3 is a block diagram depicting another embodiment of the tag reader of FIG. 1.

FIG. 4 is a block diagram depicting an embodiment of a software architecture that may be utilized in connection with tag readers such as the tag readers depicted in FIGS. 1, 2 and 3.

FIG. 5 is a block diagram depicting an exemplary platform and exemplary libraries and drivers organized in accordance with the software architecture depicted in FIG. 4.

FIG. 6 is a block diagram depicting an exemplary embodiment of the tag reader of FIG. 1 organized in accordance with the software architecture depicted in FIG. 4.

FIG. 7 is a block diagram depicting another embodiment of the tag reader of FIG. 1 that is organized in accordance with the software architecture of FIG. 4.

FIG. 8 is a block diagram depicting yet another embodiment of the tag reader of FIG. 1 that is organized in accordance with the software architecture of FIG. 4.

FIG. 9 is a flowchart depicting a method for configuring a tag reader, such as the tag reader depicted in FIG. 1.

FIG. 10 is a flowchart depicting a method for configuring a tag reader in accordance with the method depicted in FIG. 9.

FIG. 11 is a flowchart depicting another method for configuring a tag reader in accordance with the method depicted in FIG. 9.

FIG. 12 is a flowchart depicting another method for configuring a tag reader, such as the tag reader depicted in FIG. 1.

### DETAILED DESCRIPTION

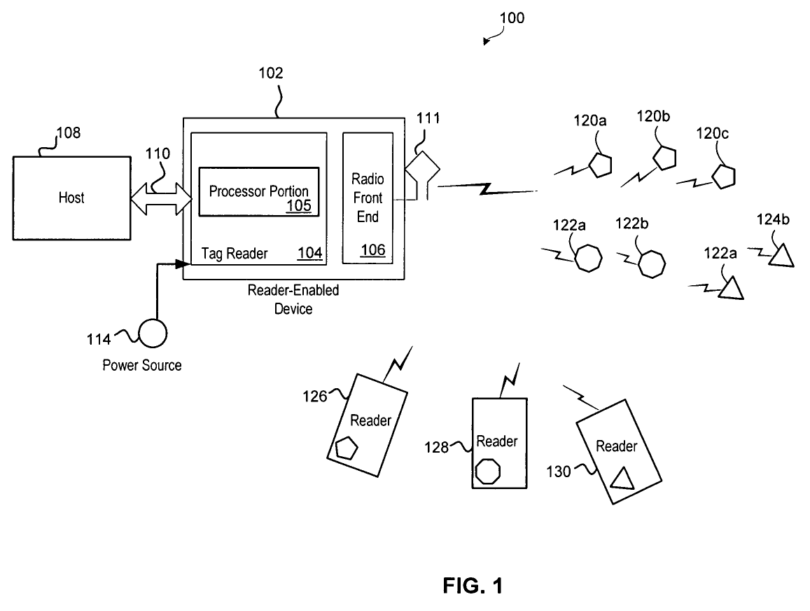

Referring now to the drawings, where like or similar elements are designated with identical reference numerals throughout the several views, FIG. 1 depicts a block diagram of a potential operating environment 100 of a configurable tag reader 104. As depicted in the exemplary embodiment, the operating environment 100 of the configurable tag reader 104 includes a reader-enabled device 102 that houses both the configurable tag reader 104 and a radio front-end 106. As shown, the configurable tag reader 104 includes a processing portion 105 and is in communication with the host 108 via a host communication link 110.

In addition, the radio front-end 106 is shown transmitting a signal 112 via an antenna 111 in the direction of a first, second and third set of tags 120a-c, 122a-b and 124a-b. In the exemplary embodiment, each of the sets of tags 120a-c, 122a-b and 124a-b includes tags of a type that differs from tags in the other sets. For example, the first set tags 120a-c may include tags manufactured by a different vendor and may use different communication protocols than the second and third sets of tags 122a-b and 124a-b.

In some embodiments, the host 108 is a general purpose computer or server adapted with software to enable the host 108 to communicate with the tag reader 104. In other embodiments the host 108 is a processor that is embedded in another device (e.g., the reader-enabled device 102) and is configured to execute instructions enabling the host 108 to communicate with the tag reader 104.

The communication link 110 may be a communication link that operates in accordance with one or more existing protocols (e.g., Ethernet, USB, 802.11, ZigBee, RS-232, Bluetooth and I2C) or other protocols developed in the future.

The reader-enabled device 102 in some embodiments is a device that functions primarily to read tags, and in other embodiments the reader-enabled device 102 is a device that has other functions. For example, the reader-enable device 102 may be any one of a variety of consumer electronics devices (e.g., a computer printer, DVD player, personal digital assistant (PDA) or radio handset (e.g., cellular telephone)) or it may be any other device that includes the tag reader 104 and radio front-end 106.

In some embodiments, the processor portion 105 is realized by a processor, a computer readable medium (e.g., volatile memory and/or non-volatile memory) and instructions encoded in the computer readable medium. As discussed further herein, in these embodiments the tag reader 104 may utilize a processor of the reader-enabled device 102 (e.g., a control processor or radio processor) or the tag reader 104 may utilize a separate application processor.

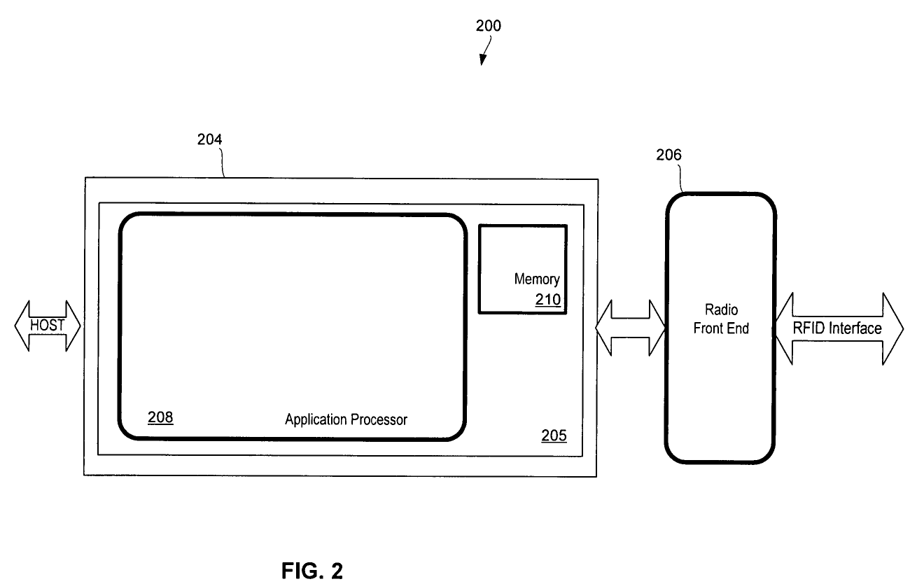

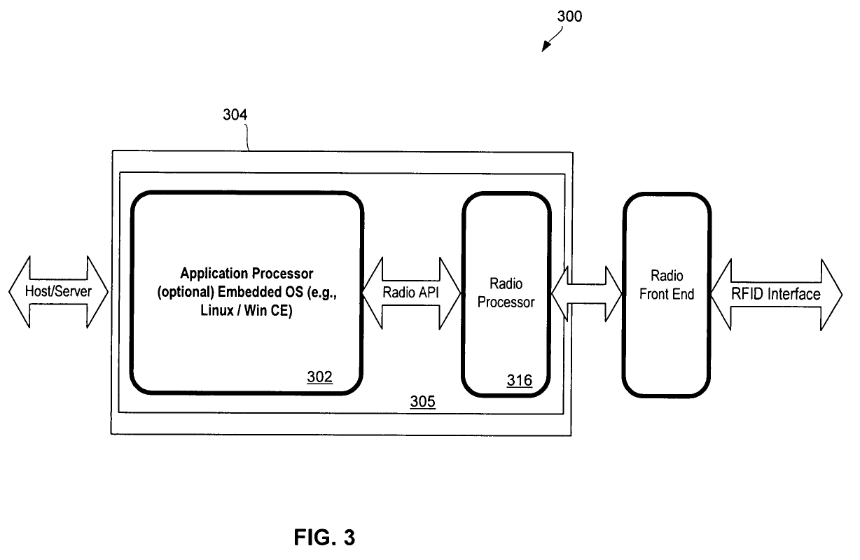

Referring briefly to FIGS. 2 and 3, for example, shown are block diagrams 200, 300 of two embodiments of the tag reader 104 depicted in FIG. 1. As shown, FIG. 2 depicts a processor portion 205 of a tag reader 204 realized with an application processor 208 configured to execute instructions from memory 210 (e.g., non-volatile memory). Tag reader 204 is also shown communicating with a radio front end 206. Block diagram 300 depicts a processor portion 305 of a tag reader 304 realized by an application processor 302 and a radio processor 316 that execute instructions from memory (not shown). It is also contemplated that in other embodiments the processor portion 305 of the tag reader 304 may be realized by the radio processor 316 in connection with instructions stored in memory.

One of ordinary skill in the art will recognize that the application and radio processors 208, 302, 316 may be realized by a variety of devices including processors sold under the brand names of PIC, AVR, ARM, PowerPC and Xscale. In yet other embodiments, the processor portion 105 of the configurable tag reader 104 is implemented by hardware or a combination of hardware and software. It is contemplated, for example, that the processor portion 105 may be realized, at least in part, by one or more of a variety of devices including field-programmable gate arrays (FPGAs), complex programmable logic devices (CPLDs), programmable logic devices (PLDs), application-specific integrated circuits (ASICs) and/or other discrete components.

In operation, the tag reader 104 is capable of receiving, via the radio front-end 106, information (e.g., data that is encoded according to a particular protocol) that is transmitted by one or more of the tags 120a-c, 122a-b and 124a-b. In addition, in several embodiments, the tag reader 104 is capable of coordinating transmission of signals (e.g., the signal 112) that cause at least a portion of the tags 120a-c, 122a-b and 124a-b to transmit information back to the radio front-end 106 and tag reader 104. As discussed further herein, depending upon the sophistication of the radio front-end 106, the tag reader 104 may utilize a variety of technologies to process (e.g., receive) the information from the tags including, for example, a digital signal processor (DSP) or an 8-bit microcontroller.

The radio front-end 106 in several embodiments is realized by analog radio components (e.g., analog transmit chain and/or receiver chain) and may be realized, for example, as a UHF or an HF radio. One of ordinary skill in the art will appreciate that there are a variety of radio front-ends that are available with varying levels of complexity. Generally, the more powerful the radio front-end 106 is (e.g., in terms of modulating/demodulating and decoding signals from tags), the less powerful the signal processing in the tag reader 104 needs to be. Some exemplary radio front-ends include radios sold under brand names including Atmel, Contactless, EM, Inside, Melexis, Philips, SkyeTek, WJ and Texas Instruments.

Also depicted in FIG. 1 is a power source 114 that is shown coupled to the reader-enabled device 102. As discussed further herein, in some embodiments the power source 114 provides power to the reader-enabled device 102 and the tag reader 104. In these embodiments, the power source 114 may be an alternating current source provided by an electric utility or it may be a direct current power source (e.g., a regulated power supply). In other embodiments, the power source 114 may not supply power to either the reader-enabled device 102 or the tag reader 104, but as discussed further herein, the tag reader 104 in some embodiments is configurable based upon one or more characteristics of the power source 114.

In addition, the exemplary environment 100 of the configurable tag reader 104 includes first, second and third readers 126, 128, 130 that are shown sending signals into the environment 100. As depicted in FIG. 1, the first reader 126 communicates in a protocol that is utilized by the first set of tags 120a-c, the second reader 128 communicates in a protocol that is utilized by the second set of tags 122a-b and the third reader 130 communicates in a protocol that is utilized by the third set of tags 124a-b.

It should be recognized that the devices depicted in the environment 100 (e.g., the host 108, reader-enabled device 102, analog front end 106, antenna 111, tags 120a-c, 122a-b and 124a-b, power source 114 and readers 126, 128, 130) are shown merely as an example of what the tag reader 104 may experience in its operating environment for purposes of discussing various embodiments of the present invention.

According to several embodiments of the present invention, the configurable tag reader 104 is configurable (e.g., manually or automatically) so as to enable the tag reader 104 to adapt to one or more aspects of its operating environment 100. In many embodiments for example, the tag reader 104 is configurable based upon one or more characteristics of the host 108, reader-enabled device 102, analog front end 106, tags 120a-c, 122a-b and 124a-b, antenna 111, power source 114, readers 126, 128, 130, users or user interfaces. In some embodiments, the tag reader 104 is configurable based upon information it receives from the tag sets 120a-c, 122a-b and 124a-b and/or the readers 126, 128, 130, and in other embodiments, the tag reader 104 is configurable based upon identifiable characteristics of its operating environment, such as temperature, acceleration and location (e.g., as identified by GPS).

As a consequence, several embodiments of the present invention enable an end user, that desires to implement a tag reader, to avoid the lengthy and often costly process of designing and building a reader (e.g., from the ground up) that is customized for a particular environment. Moreover, the tag reader 104 in some embodiments may be utilized in connection with hardware of an existing reader to provide extensibility and extendibility to an existing reader.

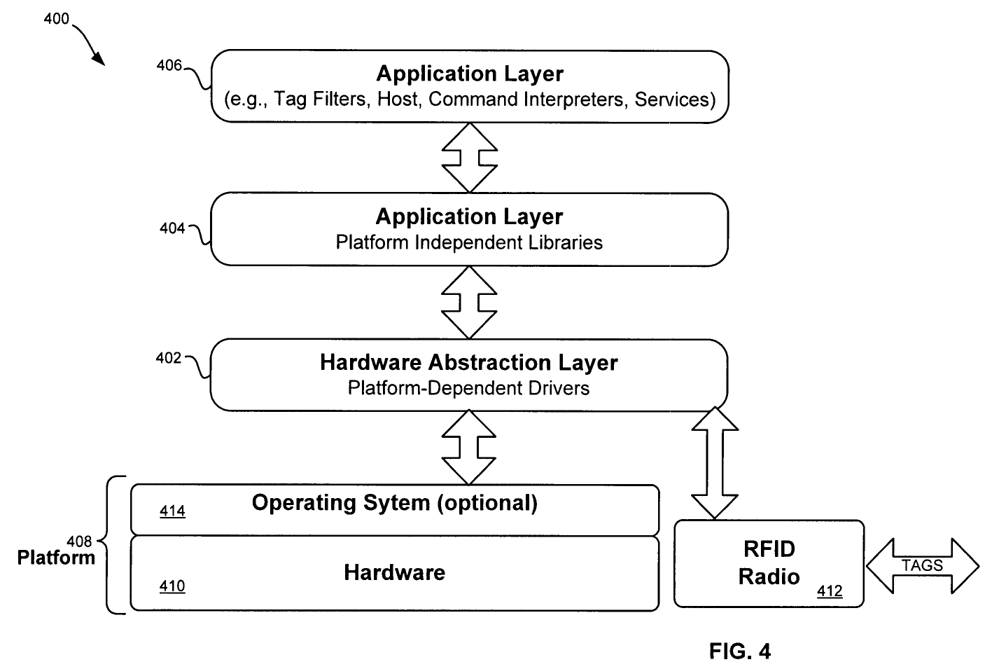

Referring next to FIG. 4, shown is a block diagram depicting a software architecture 400 that may be utilized in connection with enabling configurability of the tag reader 104, 204, 304 in accordance with several embodiments. As shown, the architecture includes three components: a hardware abstraction layer 402, an application software interface 404 and an application layer 406. Also shown is a platform 408 that includes hardware 410 that underlies the tag reader 104, 204, 304 and a radio 412 that is used in connection with the tag reader 104, 204, 304. The hardware 410 and radio 412 in the exemplary embodiment provide the physical interface to the host 108 and to the tags 120, 122, 124, respectively.

Also shown is an optional operating system 414, which may be realized by a variety of operating systems including operating systems sold under the trade names of Linux, WinCE, Symbian, and VxWorks.

The hardware abstraction layer 402 in this embodiment includes platform-dependent drivers that effectuate low-level functions to control the platform 408 of a tag reader. In the exemplary embodiment, the drivers are optimized for the hardware 410, radio 412 and the operating system 414.

The application software interface 404 includes platform-independent libraries that provide, via a common API, many of the functions associated with reading tags (e.g., tags 120, 122, 124). Advantageously, the library functions are portable across reader platforms because they are independent of embedded processors, operating systems, host interfaces and radios that reside at the platform level 408 of the exemplary architecture.

The application layer 406 in this embodiment is utilized to define the functionality of the tag reader 104, 204, 304. As discussed further herein, applications of the application layer 406 may reside with the host 108, the tag reader 104 or it may be distributed among the host 108 and the tag reader 104. To carry out desired functions, application code in the application layer 406 makes calls to the lower level library and driver functions. In several embodiments for example, the application layer 406 receives commands (e.g., from the host 108), parses and interprets the received commands and executes the commands by calling the lower level library and driver functions.

Beneficially, the application layer 406 in connection with the libraries and platform dependent drivers allows customized applications, that are directed to industry specific applications, to be created without specific knowledge of the particular underlying platform in which the tag reader 104 is embedded. As a consequence, the architecture 400 enables a developer that is familiar with software solutions for the health care industry, for example, to create an application that is portable across many different platforms; thus enabling desired functions to be carried out without the burden of understanding a variety of hardware platforms (e.g., reader hardware and reader radios).

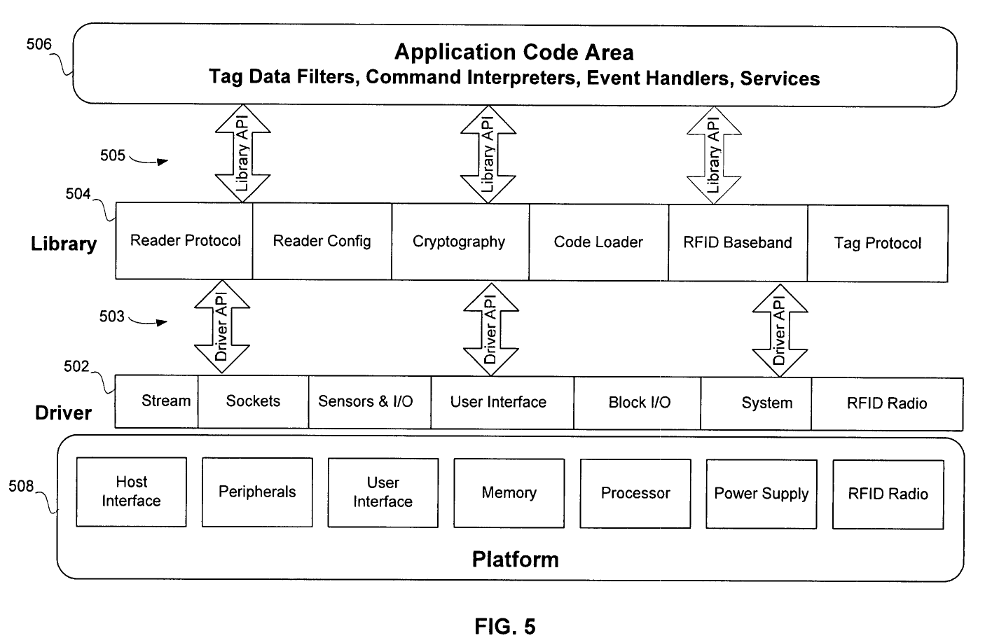

Referring next to FIG. 5, shown is a block diagram depicting exemplary drivers 502 of the hardware abstraction layer 402, exemplary libraries 504 of the application software interface 404, and components of an exemplary platform 508.

The platform 508 in this embodiment includes a host interface, peripherals, a user interface, memory, a processor, power supply and a radio. It should be recognized that this is only exemplary of the type of hardware that may be part of a platform. In an alternative embodiment for example, the platform 508 may have an operating system, and in another embodiment the platform 508 may not have a user interface.

The drivers 502 in this embodiment provide interface handling for the hardware of the platform 508. Advantageously, the API 503 to the drivers 502 is portable and platform independent while the driver functions are dependent upon the platform 508. As a consequence, a developer need only learn the API 503 calls to the drivers 502 in order to create code that is applicable across a variety of platforms. As shown, the drivers in this embodiment include stream drivers, sockets drivers, sensors and I/O drivers, user interface drivers, block I/O drivers, system drivers and radio drivers.

The stream drivers are functions that provide hardware interface handling for communication with a host (e.g., the host 108) or other peripheral devices. For example, stream drivers may include drivers for TTL, I2C, SPI, USB and RS-232. Beneficially, a collection of stream drivers may be stored on a tag reader (e.g., the tag reader 104, 204, 304) to enable the tag reader to communicate with a variety of host interfaces.

The socket drivers are functions that enable task management, port sharing among multiple applications and networking management functionality. Some examples of socket drivers include Ethernet, Wi-Fi, Zigbee, Bluetooth, etc.

The sensor and I/O drivers are functions that provide hardware interface handling for communication with sensors and other I/O devices that are connected to the hardware of the platform 508. For example, sensor drivers may include drivers for temperature sensors, current sensors and voltage sensors and the I/O drivers may include drivers for general purpose I/O (GPIO).

The user interface drivers are functions that provide hardware interface handling for communication with the user interface of the platform 508. For example, the user interface driver may include drivers for touch screen hardware, pointing devices, biometric security devices and keyboards.

Block I/O drivers are functions that enable communications with memory and other platform resources (e.g., hard drives, busses, ROM, RAM, EEPROM, etc.).

The system drivers include drivers that provide an interface to various system components of the platform hardware. For example, the system drivers may include drivers for timers, power management and interrupts of the platform hardware.

The radio drivers include drivers that provide an interface to a variety of radio types (e.g., analog front ends (AFEs)) so as to enable communications with a variety of radios with a platform independent API 503. As discussed further herein, this enables the tag reader 104, 204, 304 utilizing the software architecture depicted in FIG. 5 to be utilized in connection with a wide range of radio types. Moreover, if a user desires to upgrade a radio of a reader-enabled device, the tag reader 104, 204, 304 employing the architecture depicted in FIG. 5 may simply change radio drivers to the radio driver of the new radio.

As shown, the library 504 in this embodiment is accessible via a portable and platform-independent API 505 so as to be applicable across a variety of processors and radios. As depicted, the library 504 includes a reader protocol library, reader configuration library, a cryptography library, a code loader library, an RFID baseband library and a tag protocol library.

The reader protocol library in the exemplary embodiment includes functions that implement many low-level operations performed by typical host communication protocols. For example, the reader protocol library may include a cyclical redundancy code (CRC) library, a parity calculation library, forward error correction algorithms, message data parsers, ASCII to hexadecimal encoders and decoders, host-protocol command interpreters, host-protocol command executors and host-protocol error handlers.

It should be recognized that a reader-side implementation of a host-to-reader communication protocol may reside in the reader protocol library, the application code area 506 or both. For example, an open-source application marketed under the trade name of SkyeTek Protocol Command Interpreter (SPCI) resides within the application code area 506 and makes calls to the functions in the reader protocol library as well as other libraries and the drivers 502.

The reader configuration library includes functions that enable an application within the application code area 506 to control the inner workings of the tag reader 104, 204, 304. For example, default values and runtime values may be established, and modes of operation, performance tradeoff algorithms and other user configurable aspects of the tag reader 104, 204, 304 may be implemented in the reader configuration libraries. In addition, schedule, event, interrupt and priority handlers may also be implemented in the reader configuration libraries.

The cryptography library in this embodiment handles the security and cryptographic data processing that may be required relative to many aspects of the tag reader 102, 204, 304. For example, the cryptography library may include tag-reader cryptography, reader-host cryptography, user data security, network data security and hardware security management.

A variety of cryptographic techniques may be utilized including private key algorithms and proprietary security algorithms (e.g., security algorithms marketed under the trade names of Philips, Mifare, Inside, Contactless, Pico Pass, Infineon, My-d, Atmel, CryptoRF, etc.). In addition, public key algorithms may be utilized including PGP and commonly known algorithms such as DES, 3-DES and RSA, for example.

The tag protocol library in this embodiment defines one or more of the air interface; initialization and anti-collision procedures; and the data transmission method utilized for the forward and return links. The air interface describes characteristics of baseband radio functionality and RF symbol definitions, which define how data bits are sent and received through the air via the RFID interface.

The initialization and anti-collision procedures describe how a tag reader and a tag interact to communicate unique or repeated tag identification numbers from tag(s) to the reader. The data transmission method that is defined by the tag protocol library describes how the forward and return link messages are constructed, encoded and recoded to perform basic RFID transactions including, for example, identifying, reading and writing RFID tags.

In some variations, the tag protocol library is segregated into three general classes of functions: agnostic functions, which provide the highest level of abstraction so that applications operating in the application code area 506 may operate independent of tag types that the tag reader 104, 204, 304 may experience; protocol functions, which allow applications to utilize a particular tag type without concern for tag manufacturer-specific implementations; and manufacturer functions, which enable applications to access the manufacturer-specific features of a standards-based tag and utilize proprietary tag protocols from independent tag manufacturers.

In the context of high frequency (HF) air interfaces (e.g., 13.56 MHz), the tag protocol library may support a variety of protocols including, but certainly not limited to, ISO156693-2, ISO18000, ISO14443-2 Type A, ISO14443-2 Type B, Phillips ICode SL1, Texas Instruments Tag-it HF and TagSys C210, C220 and future protocols. With respect to ultra high frequency (UHF) air interfaces (e.g., 860-960 MHz), the tag protocol library may support protocols including, but not limited to, ISO18000-6A, ISO18000-6B, EPC Class 0/0+, EPC Class 1, EPC Class 1 Gen 2, and other protocols yet to be developed.

The RFID baseband library in the exemplary embodiment includes functions that are portable across disparate hardware chips, processors and operating systems (if present). The RFID baseband functions handle low-level interaction between the tag protocol library and the platform-dependent RFID radio drivers. In addition, the RFID functions digitally define the RF characteristics of individual bit symbols (i.e., RF signals corresponding to individual bits of data that are read and written to RFID tags) and presents the defined symbol definitions to the low-level, protocol specific, RFID radio drivers so as to enable the tag protocol library functions to see only binary code (i.e., ones and zeros).

The code loader library in the exemplary embodiment includes functions that facilitate the loading of new code and/or data. For example, the code loader includes functions to load programs into the application code area 506, functions to load new drivers to the set of drivers 502, functions to load new configuration data or default values for the tag reader 104, 204, 304 and functions to add new functions to the libraries 504.

As an example of the functionality of the code loader library, if a developer is assisting a customer that is seeking a new technology, and the technology requires the addition of a new radio circuit to accommodate a specialty RFID radio tag and protocol, when the new radio is added, the developer simply adds a new radio driver to the set of drivers 502 and adds the required symbol definitions and handling functions to the RFID baseband and tag protocol libraries, respectively. The developer is then able to write application specific programs (e.g., that reside on the tag reader 104, 204, 304 and/or the host 108), which make function calls to the newly added functions that control the new radio hardware and handle the new tag protocol.

Although the software architecture depicted in FIG. 4 enables the tag reader 104, 204, 304 to be easily configured in response to an environment of the tag reader 104, 204, 304, it should be recognized that the software architecture is exemplary only and that variations to one or more aspects of the architecture depicted in FIG. 4 may be made without departing from the scope of the present invention. Moreover, the specific hardware, drivers, libraries and applications described with reference to FIG. 5 are exemplary only. Certain functions may be omitted, combined or enhanced without departing from the scope of the present invention.

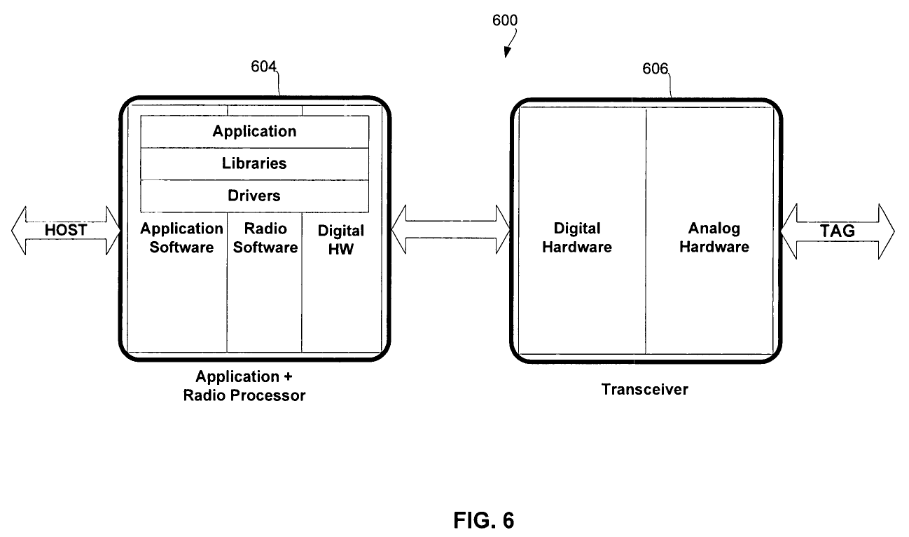

As described with reference to FIGS. 6, 7 and 8, software designed in accordance with the architecture of FIGS. 4 and 5 in some embodiments resides solely within the tag reader 104, 204, 304, and in other embodiments resides within both the tag reader 104, 204, 304 and the host 108. As a consequence, the tag reader 104, 204, 304 in some embodiments is configurable from software embedded at the tag reader 104, 106, 108 and in other embodiments is configurable from software that resides on the host 108 and in yet other embodiments is configurable utilizing software that resides on both the tag reader 104, 204, 304 and the host 108.

Referring to FIG. 6, shown is a block diagram of an embodiment of a reader system 600 depicting a tag reader 604, which is one embodiment of the tag reader 104 depicted in FIG. 1. As shown, tag reader 604 is in communication with a transceiver 606, which includes digital hardware and analog hardware. As shown, the tag reader 604 in this embodiment is realized by both an application processor and a radio processor, which execute software that is organized in accordance with the software architecture described with reference to FIGS. 4 and 5. As shown, the tag reader 604 in this embodiment includes application software, radio software and digital hardware. The application software in this embodiment resides in an application code area (e.g., the application code area 506), which utilizes a library API (e.g., the library API 505) and a driver API (e.g., driver API 503) to carry out its intended function.

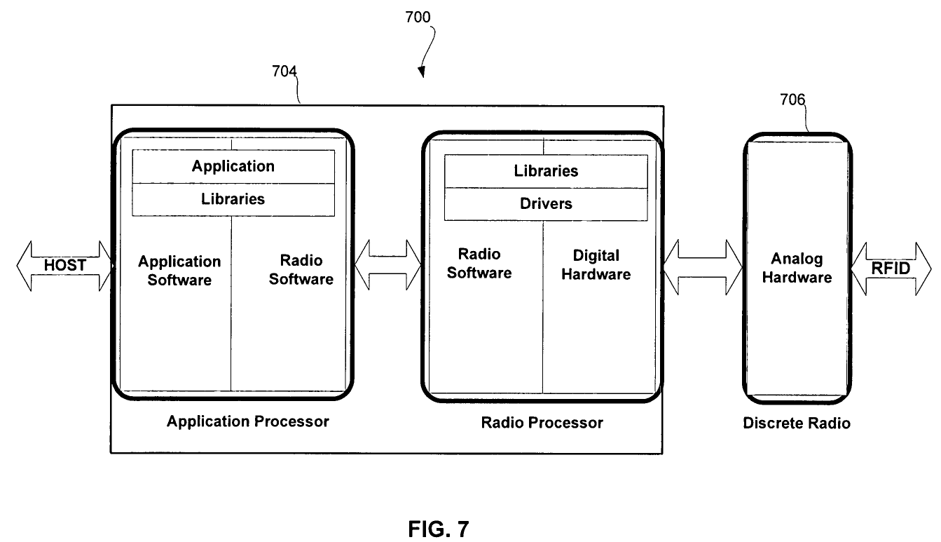

Referring next to FIG. 7, shown is a block diagram of another reader system 700 that includes a tag reader 704, which is another embodiment of the tag reader 104 depicted in FIG. 1. As shown, the tag reader 704 is in communication with analog hardware 706, and is realized by both an application processor and a radio processor (e.g., radio processor 316) as well as software that is organized in accordance with the architecture described with reference to FIGS. 4 and 5. In this embodiment, however, the application processor executes application software and some libraries while the radio processor executes other libraries and platform specific drivers (e.g., drivers 502).

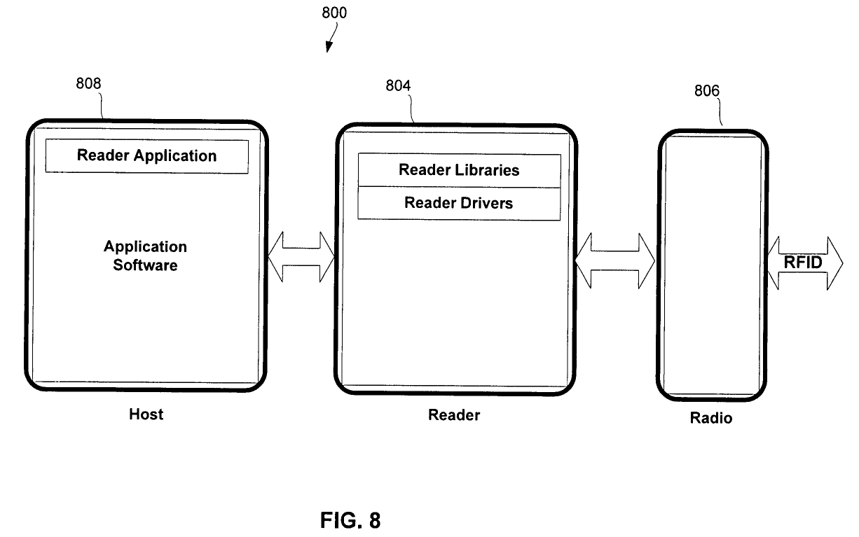

Referring next to FIG. 8, shown is yet another embodiment of a reader system 800, which includes a tag reader 804, which is another embodiment of the tag reader 104 depicted in FIG. 1. As shown, a host 808 in this embodiment executes application software to configure and/or control the tag reader 804, and the tag reader 804 includes portable library and driver APIs that are accessed by the application software residing within the host 808. In accordance with several embodiments discussed further herein, the tag reader 804 is configured at least in part by the host 808 in response to one or more environmental characteristics of the tag reader 804. As shown, tag reader 804 is also in communication with a radio 806, which may represent radio front end 106, FIG. 1, for example.

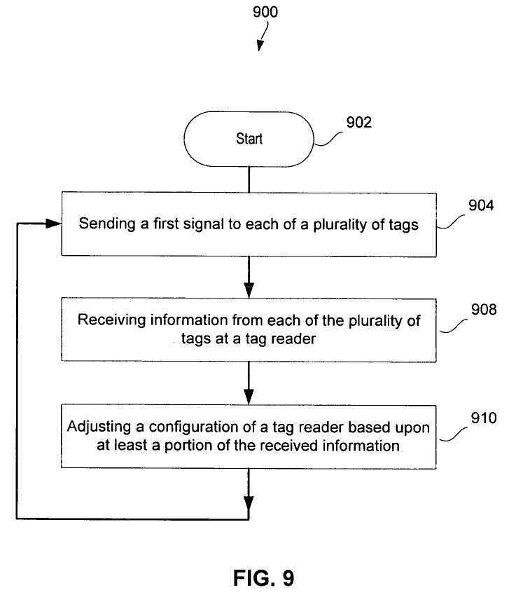

Referring next to FIG. 9, shown is a flowchart depicting steps of a method 900 carried out to configure a tag reader in accordance with several embodiments of the present invention. While referring to FIG. 9, simultaneous reference will be made to FIG. 1, but it should be recognized that the method described with reference to FIG. 9 is certainly not limited to the specific embodiments described with reference to FIG. 1. As shown in FIG. 9, a signal is initially sent to each of the tags 120, 122, 124 (Blocks 902, 904), and in response, the tags 120, 122, 124 transmit information that is received at the tag reader 104 (Block 908).

In several embodiments, the signal sent to the tags originates from the tag reader 104 (e.g., the signal 112), but in other embodiments, one of the other readers 126, 128, 130 sends a signal that prompts the tags 120, 122, 124 to transmit the information back to the tag reader 104. In response to the received information, the configuration of the tag reader 104 is adjusted based upon at least a portion of the received information (Block 910).

As discussed further herein, various aspects of the tag reader 104 may be configured based upon information received from the tags 120, 122, 124. For example and without limitation, a tag search order, forward link signal power, reverse link sampling rate and forward link modulation depth may be adjusted based upon the received information from one or more of the tags 120, 122 and 124.

In some embodiments, the analysis of the received information is carried out at the tag reader 104 and in other embodiments it is carried out at the host 108. In yet other embodiments, the received information from the tags 120, 122 and 124 is analyzed at both the host 108 and the tag reader 104. Moreover, the configuration of the tag reader 104 may be carried out automatically or a user may configure the tag reader based upon the analyzed information.

In several embodiments, the information received from the tags 120, 122 and 124 is analyzed by configuration code at the application layer 406 that resides at the host 108, the tag reader 104 or both the host 108 and the tag reader 104. In these embodiments, the configuration code may automatically adjust the configuration of the tag reader 104 or it may provide information to a user (via a user interface at the host 108 or reader-enabled device 102) that enables the user to adjust the configuration based upon the information received from the tags 120, 122 and 124.

As discussed with reference to FIGS. 4 and 5, the configuration code in some embodiments is platform independent code that utilizes the platform independent library API 505 to call functions in the library 504 in order to make changes to the configuration of the tag reader 104. In turn, the library 504 calls the platform specific drivers 502 via the driver API 503 to carry out configuration changes to the tag reader 104.

In some embodiments, an order in which the tag reader 104 searches for tags 120, 122, 124 is changed in response to received information from the tags 120, 122, 124, or in response to other information, such as the order in which signals according to various RFID tag protocols are sent. For example, if the information received from the tags 120, 122, 124 indicates that there are more of one particular type of tag than other types of tags, the configuration of tag reader 104 may be changed to initially look for the particular or predominant type of tag (e.g., by initially sending a signal with a frequency and protocol that complies with the particular or predominant type of tag). Also, in certain embodiments, tag reader 104 may automatically adjust the tag search order (e.g., via software or hardware of tag reader 104 or of host 108). Alternatively, a user may adjust the tag search order based upon the information available at tag reader 104.

In operation, it is possible that the tag reader 104 may not know which tag types it will encounter. Open loop systems, such as used by large retailers, are examples of environments where many different tag types may be in use. Open-loop applications, such as those used to manage supply chains, involve the stores and their suppliers, so that the entity tagging objects is different from the entity that primarily uses the tagged objects. In closed-loop applications, (e.g., applications the automotive industry has been using for several years), both the product being manufactured and the component materials are tagged in the same environment.

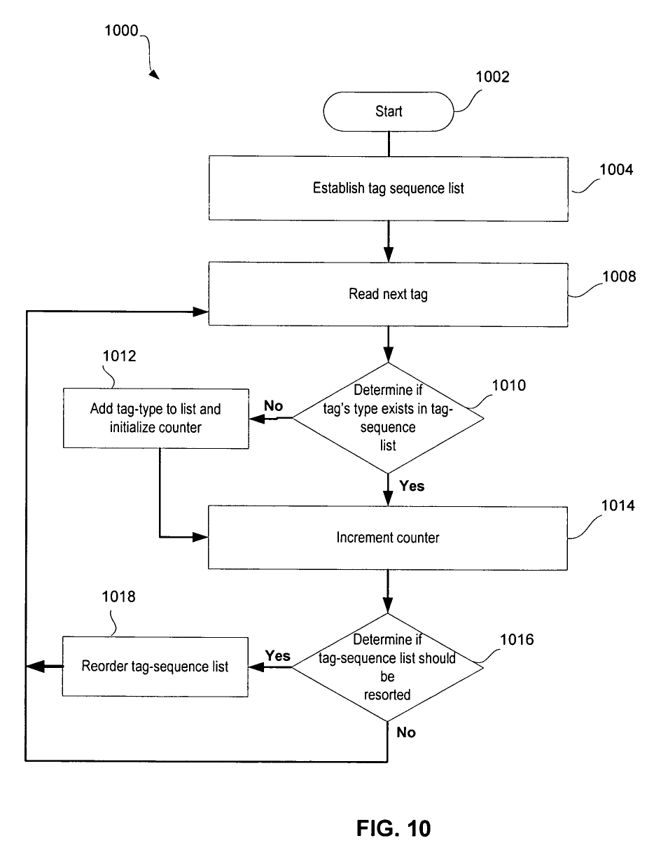

In one embodiment of the system, the tag reader 104 is enabled to automatically scan through a set of tag protocols in order to communicate with tags from multiple vendors, each of which may use different wireless communication protocols. Referring for example to FIG. 10, shown is a flowchart of one possible method 1000 to scan tags. As shown, an initial tag sequence list is established (e.g., a default sequence list) (Blocks 1002, 1004), and as each tag is read in the initial sequence list (Block 1008), a determination is made as to whether the tag-type that is read is a type that has already been encountered (Block 1010).

If the tag-type has not been read before, an entry for the tag-type and an associated counter is added to the list (Block 1012). For each tag read, the counter is incremented (Block 1014), and based upon the quantity of each of the tag types encountered, the list is re-ordered (Blocks 1016, 1018). In some embodiments, the tag read sequence is reordered periodically and in other embodiments the tag read sequence is reordered when requested. Beneficially, reconfiguring the sequence allows the system to scan first for tags that are more likely to be found based on past experience. In this way, scanning of the most frequently encountered tags may be performed more quickly.

In variations, another aspect of the tag reader 104 that is configurable is a transmit power level. In several embodiments, for example, the tag reader 104 is configurable so as to be capable of adjusting a transmit power of the radio front end 106 based upon the reliability of information transmitted from the tags 120, 122, 124. In one implementation, for example, the transmit power is initially set to a high power (e.g., maximum power) and the power is incrementally reduced up to a point just before a bit error rate of information received from the tags 120, 122, 124 reaches an unacceptable level. Beneficially, reducing transmit power levels often results in less interference between readers, better regulatory compliance with respect to system emissions, and/or longer periods of use for rechargeable readers.

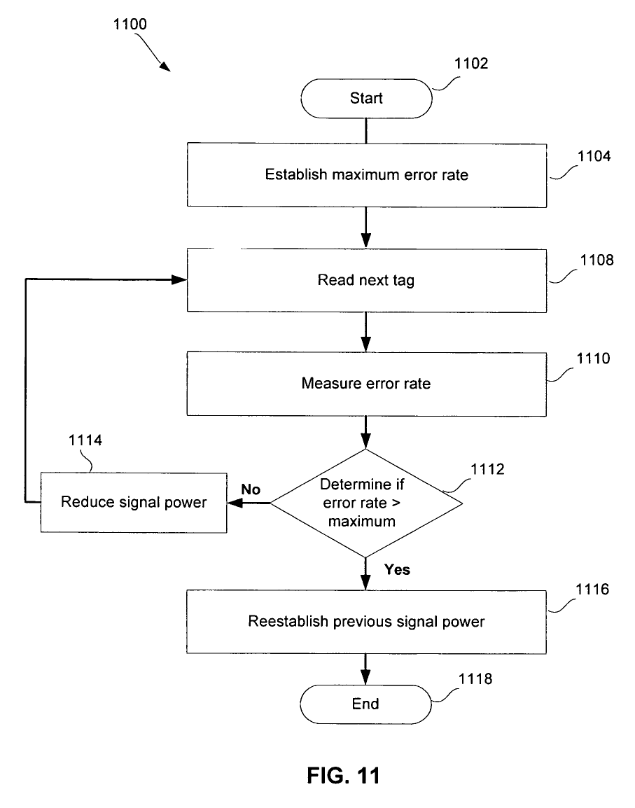

Referring next to FIG. 11, shown is a flowchart depicting a specific transmit power-management method 1100 in accordance with one embodiment. As shown, a maximum tolerable error rate (e.g., bit error rate) is first established (Blocks 1102, 1104). In some embodiments this maximum error rate is set manually and in other embodiments, it is pre-programmed as part of default settings for the tag reader. As depicted, the reader then scans a tag and measures the error rate (Blocks 1108, 1110). This measurement may be calculated using an error indicator from the tag that was read, and in addition may include information about prior error counts.

Next, this error rate is compared to the maximum error rate (Block 1112), and if the error rate is still acceptable using a lower-powered signal, the signal power is reduced further (Block 1114). If the error rate has risen to an unacceptable level, the previous signal power, which was sufficient to scan tags with an acceptable error rate, is re-established (Block 1116) and method 1100 ends (Block 1118).

In several embodiments, the tag reader 104 is also configurable so as to adjust a sampling rate of the information received from a tag. In general, the higher the number of samples per bit of information that the tag reader 104 takes, the greater the read range that the tag reader 104 will have. Increasing the number of samples, however, requires additional processing power to perform real-time or post-processing of the sampled information, and may require additional memory to store the received information. Moreover, post-processing generally decreases response time and throughput, whereas processing in real-time increases power consumption. As a consequence, the selected sampling rate in many embodiments is selected to provide a desirable balance between read range and throughput. This balance may be adjusted by a user or may be adjusted automatically based upon one or more characteristics of a platform (e.g., the platform 508) of the tag reader 104. For example, if the platform of the tag reader 104 includes a relatively large amount of available memory and/or a sufficient processing power, the sampling rate may be increased.

In yet other embodiments, the tag reader 104 is configurable so as to adjust a modulation depth of forward link signal transmissions (i.e., from reader to tag) based upon the information received from the tags 120, 122, 124. In some embodiments for example, a modulation depth of the signal transmitted from the reader-enabled device 102 is varied through a range of modulation depths to determine a level of tag performance over the range of modulation depths and/or a level of spurious emissions from the forward-link signal over the same range of modulation depths.

In some variations, the tag reader 104 is adapted to scan through a range of modulation depths and determine where, in a known modulation depth operating range, a particular tag operates at a high performance level. For example, if a particular tag type operates in accordance with a protocol that allows a modulation depth between 30% and 70%, the tag reader 104 in these embodiments varies the modulation depth of the forward-link signal 112 through a range of modulation depths from 70% to 30% to determine where the tag type operates with the highest reliability.

Alternatively, the tag reader 104 in other variations is adapted to scan through a range of modulation depths to determine a lowest modulation level at which forward link signal 112 may be transmitted (e.g., to reduce spurious emissions) while maintaining a minimum reliability level. In one embodiment, for example, the tag reader 104 is adapted to begin transmitting the forward link signal 112 at a high modulation depth and reduce the modulation depth as much as possible while maintaining a desired level of reliability for the particular tag type. In this way, the level of spurious emissions from the forward link signal 112, which increase with greater modulation depths, are reduced while maintaining a desired level of performance.

In some embodiments, it is contemplated that the tag reader 104 scans through a range of modulation depths for each of the tag types 120, 122, 124 so as to establish a modulation depth for each tag type 120, 122, 124. In this way, either performance may be maximized, spurious emissions minimized or a balance between performance and spurious emissions may be established for each tag type.

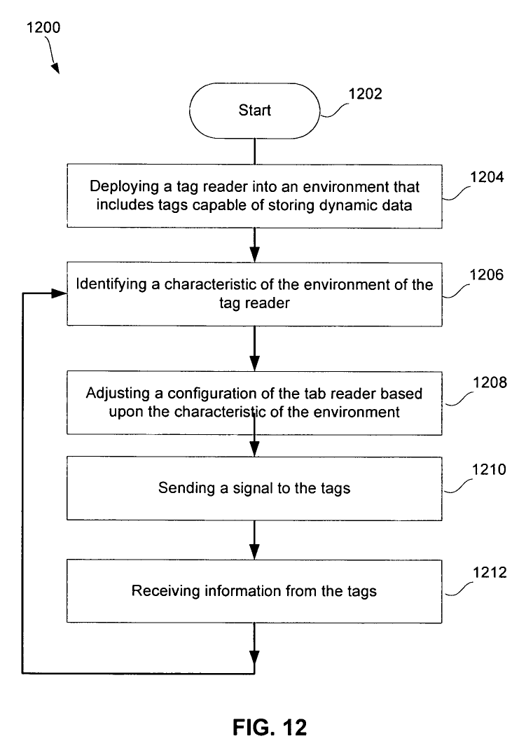

Referring next to FIG. 12, shown is a flowchart depicting a method 1200 for configuring a tag reader in accordance with another embodiment. As shown, a tag reader is initially deployed in an environment that includes tags capable of storing dynamic data (Blocks 1202, 1204). Referring, for example, to the exemplary environment 100 depicted in FIG. 1, the tag reader 104 is deployed in the environment 100, which includes the host 108, the reader-enabled device 102, the radio front end 106, the antenna 111, the power source 114, other readers 126, 128, 130, transmissions from the other readers, tags 120, 122, 124 and transmissions from the tags 120, 122, 124.

It should be recognized that the environment 100 of the tag reader 104 may vary depending upon the particular embodiment of the tag reader 104. In some embodiments for example, the tag reader 104 is integrated into the reader-enabled device 102 and in other embodiments the tag reader 104 is a module that is separable from the reader-enabled device 102. Moreover, the radio front end 106 in some embodiments is integrated with the tag reader 104 and in other embodiments, the radio front end 106 is a module that is separable from the reader-enabled device 102 and the tag reader 104. As a consequence, in some embodiments the radio front end 106 and/or the reader-enabled device 102 are potentially dynamic components of the environment 100 of the tag reader 104, and in other embodiments the radio front end 106 and/or the reader-enabled device 102 are fixed components in the environment 100 of the tag reader 104.

As shown in FIG. 12, one or more characteristics of the environment of the tag reader 104 are identified and a configuration of the tag reader 104 is adjusted based upon the characteristic(s) of the environment (Blocks 1206, 1208). As discussed further herein, some examples of identifiable characteristics of the environment 100 include characteristics of the host 108, the host communication link 110, the reader-enabled device 102, the radio front end 106, the antenna 111, the power source 114, the readers 126, 128, 130 (e.g., transmission protocols and/or power) and the tags 120, 122, 124 (e.g., transmission protocols and/or power).

As shown in the exemplary method depicted in FIG. 12, the tag reader 104 sends a signal to the tags 120, 122, 124 and receives information from the tags in accordance with its configuration (Blocks 1210, 1212). In some embodiments, the signal 112 transmitted from the tag reader 104 is altered based upon the configuration of the tag reader 104, but this is certainly not required, and in other embodiments adjustments to the configuration of the tag reader 104 do not affect the transmission of the signal 112. In some variations, for example, the tag reader 104 may merely adjust its power regulation depending upon the power source 114 or it may adjust the protocol it uses to communicate with the host 108 based upon the type of the host 108.

In some embodiments, the identified characteristic(s) of the environment 100 (Block 1206) is identified by the host 108 and in other embodiments the identification is carried out at the tag reader 104. In yet other embodiments, the identified characteristic(s) is identified at both the host 108 and the tag reader 104. Similarly, adjustments to the configuration of the tag reader 104 may be initiated at the host 108, the tag reader 104 or both the host 108 and the tag reader 104. In addition, adjustments to the configuration of the tag reader 104 may be stored on, and hence, dictated by the tags 120, 122, 124. Moreover, the configuration adjustments may be carried out automatically or a user may configure the tag reader 104 based upon the identified characteristic(s) of the tag reader environment 100.

In several embodiments, the analysis of the identified characteristic(s) is carried out by configuration code at the application layer 406 that resides at the host 108, the tag reader 104 or both the host 108 and the tag reader 104. In these embodiments, the configuration code may automatically adjust the configuration of the tag reader 104 or it may provide information to a user (via a user interface at the host 108 or reader-enabled device 102) that enables the user to adjust the configuration based upon the identified characteristic(s).

As discussed with reference to FIGS. 4 and 5, the configuration code in some embodiments is platform independent code that utilizes the platform independent library API 505 to call functions in the library 504 in order to make changes to the configuration of the tag reader 104. In turn, the library 504 calls the platform specific drivers 502 via the platform independent driver API 503 to carry out configuration changes to the tag reader 104.

In some embodiments, the configuration of the tag reader 104 is adjusted based upon one or more characteristics of the antenna 111. In this way, the tag reader 104 may be configured to operate most effectively within the geographical location that the antenna 111 is designed to operate within. For example, the configuration of the tag reader 104 may be adjusted so as to operate with a frequency and/or power level that is utilized by readers in the geographic location that the antenna 111 is designed to operate within.

More specifically, the frequency bands that are allocated to tag readers vary between North America, Europe and Asia, therefore, the antennas designed to operate in each region often differ from antennas designed to operate in other regions. One antenna, for example, may be designed to operate in a frequency band from 860 to 870 MHz (e.g., a European frequency band), another antenna may be designed to operate in the range of 902 to 928 MHz (e.g., a North American frequency band) and yet another antenna may be designed to operate in a band from 950 to 956 MHz (e.g., a Japanese frequency band).

In accordance with several embodiments, the configuration of the tag reader 104 is adjustable to change one or more of its transmission frequency, power and/or transmission protocols based upon the antenna 111 it is coupled to. As a consequence, the tag reader 104 in accordance with many embodiments is adaptable so as to be capable of being deployed in a variety of geographical locations.

In some variations, one or more characteristics of the antenna 111 are identifiable by electrical characteristics of the antenna 111. For example, antennae designed for each operating region may each be assembled with a particular resistor coupled to it so that when the particular regional antenna is coupled to the radio front end 106 the resistance of the resistor is identified and associated with a particular region, and hence, appropriate configuration of the tag reader 104.

In other variations, antennas designed for each region may be designed with a particular mechanical coupling that is detected when the antenna 111 is coupled to the reader-enabled device 102. For example, the antenna 111 may be configured to close different switches of reader-enabled device 102 (or radio front end 106) or electrically couple different pins of reader-enabled device 102 (or radio front end 106).

In yet other variations, a frequency response of the antenna 111, and hence, the frequency band it is designed to operate within, may be identified by any known techniques including use of particular algorithms and circuits such as directional couplers, RF detectors, RF power feedback circuits and other similar devices.

Although several embodiments of the present invention are described in the context of an RFID tag reader, it should be recognized that other types of radio enabled devices may be configured in accordance with a type of antenna the devices are coupled to. For example, a radio handset (e.g., cellular telephone) may be configurable based upon a characteristic of the antenna the handset is couple to. In this way, handsets may be designed for a variety of operating environments (e.g., a variety of operating frequencies, interference levels, environmental aspects, geographical areas, etc.) that are associated with one or more characteristics of the antennas used in the environments.

In some embodiments, the tag reader 104 utilizes an antenna multiplexer, which enables several antennas (e.g., sixteen antennas) to be utilized in connection with the tag reader 104. In these embodiments, the tag reader 104 is configured to discover which of a potential number (e.g., sixteen) antennas is present, healthy and have tags associated with them. With this information, the tag reader 104 may scan the antennas in an antenna scan search order that may be established based on the types of tags that are in the environment 100 of the tag reader 104, the location of the tags, the presence of other readers in the area of each antenna as well as other factors.

Other characteristics that may be identified in the tag reader's environment include one or more characteristics of the device 102 that the tag reader 104 is deployed in. In some embodiments, for example, the tag reader 104 may detect one or more characteristics of the reader-enabled device 102 it is embedded within. In variations for example, the tag reader may be configured to sense a particular electromagnetic signature of the device 102 it is embedded within.

Alternatively, the tag reader 104 may attempt certain types of communications with the reader-enabled device 102 and identify characteristics of the device 102 based upon a response it receives back from the device 102. In other embodiments, the reader-enabled device 102 may be designed so as to identify itself to the tag reader 104 (e.g., by a mechanical interface or by sending an identifying signal to the tag reader 104). In yet other embodiments, the tag reader 104 may collect one or more pieces of information from an unknown type of reader-enabled device 102 and attempt to communicate with a remote server (e.g., via the Internet) to try to match the collected information with up-to-date data relating to identified reader-enabled devices.

In response to the identified device characteristic, the configuration of the tag reader 104 may be changed in one or more of a variety of ways including, but not limited to, signal transmission power, signal modulation depth, signal transmission protocol and tag search order.

Advantageously, the ability to configure the tag reader 104 based upon a characteristic of the reader-enabled device 102 it is utilized with allows a single tag reader 104 to be utilized in a variety of devices. For example, a tag reader that is designed to operate with label printers (i.e., devices that both program RFID tags and print to tag labels at the substantially same time) may be designed to be configured with any one of a variety of label printers sold under different trade names. As a consequence, tag readers 104 in accordance with several of these embodiments may be produced and deployed at a relatively low cost.

As previously discussed, the tag reader 104, may be realized in a variety of forms including embedded software residing on a chip that is coupled with other hardware (e.g., hardware associated with host and tag communications). In other embodiments, the tag reader 104 is realized by software that ports to a main processor of the reader-enabled device 102. In addition, it should be recognized that the configuration changes may be initiated by application code (e.g., residing at the application layer 406) residing at the host 108, the tag reader 104 or both the host 108 and the tag reader 104.

In many variations, the tag reader 104 is configured to control the radio front end 106 so as to hop between frequencies in response to interference levels in the tag reader environment 100, regulatory rules in the tag reader environment 100 or both interference and regulatory rules in the environment 100 of the tag reader 104. In the context of the United States, for example, potential operating frequencies that are set aside for the tag reader 104 include the range from 902 MHz to 928 MHz. Within this frequency band, regulations require that devices frequency hop between 25 or 50 frequency channels so that transmissions on each channel occur for an equal amount of time. Within each of these 25 or 50 channels, however, there are many subchannels that a device may use for transmissions. In other words, the device must hop to each of the 25 or 50 channels, but the device has discretion within each channel as to which subchannel it may utilize.

In accordance with several embodiments, the tag reader 104 is configurable to hop to particular subchannels based upon identified interference levels existing at each of the subchannels. In some embodiments, for example, the radio front end 106 first tunes to each subchannel and measures an amount of noise present on that subchannel. Then, the subchannels with the lowest levels of noise are selected as the 25 or 50 channels. These selected 25 or 50 subchannels are then utilized by the tag reader 104 when reading tags so as to operate the tag reader 104 at frequencies less prone to interference.

The tag reader 104 in many embodiments is also configurable based upon the particular radio front end 106 that is utilized in connection with the tag reader 104. In these embodiments, a characteristic of the radio front end 106 is identified and based upon the identified characteristic (e.g., manufacturer and/or model), a driver for the radio front end 106 is selected. As discussed with reference to FIG. 5, the tag reader 104 in some embodiments includes a collection of radio drivers, and each of the radio drivers is designed for a specific type of radio front end, yet each driver is accessible by a platform independent driver API 503.

In some variations, the type of radio front end 106 is identified by sequentially sending commands (e.g., from the combined radio and application processor 208 or the radio processor 316) for different radio types to the radio front end 106 and waiting for a reply from the radio front end 106. In other words, by receiving a specific response to a specific command for a particular radio type, the radio front end 106 may be identified.

It should be recognized that this technique is merely exemplary and that one of ordinary skill in the art will recognize that there are other ways to identify one or more characteristics of the radio front end 106. For example, a pin configuration or power draw of the radio front end 106 may be utilized in other embodiments.

Once the radio front end 106 is identified, the corresponding driver is selected and utilized by the tag reader 104. As a consequence, the tag reader 104 in many embodiments may be realized and sold as a self-contained, generic tag reader that purchasers are able to design their own hardware around using any one of a variety of radios.

In some variations, the tag reader 104 is also configurable based upon signals received from the tag readers 126, 128, 130 operating in the environment 100. For example, if the other tag readers 126, 128, 130 are broadcasting in close proximity to the tag reader 104, the tag reader 104 may be able to reduce or eliminate transmitting its own signals to save power. In some embodiments the tag reader 104 listens for tags responding to commands from adjacent readers 126, 128, 130 and adjusts the power of its transmissions. For example, the tag reader 104 may “hear” other tag readers 126, 128, 130 broadcasting tag commands at sufficient power levels, while the tag reader 104 “hears” tags responding to the other readers 126, 128, 130.

The tag reader 104 in many variations is configurable based upon a type of protocol the host communication link 110 utilizes. Referring to FIG. 5, for example, when the tag reader 104 is first coupled to the host 108, the tag reader 104 identifies the type of host interface that resides on the platform 508 of the reader-enabled device 102 and selects a stream driver from the collection of stream drivers available in the drivers 502 of the tag reader 104. As discussed, the host interface may be designed to use one or more of a variety of protocols including, but not limited to, TTL, I2C, SPI, USB, RS-232, Ethernet, 802.11 and 802.14.

As discussed with reference to FIGS. 4 and 5, in many embodiments, application code includes instructions to initiate or receive communications to/from the host 108, but the application code utilizes the platform independent library API 505 and/or platform independent driver API 503 to initiate the communications. As a consequence, end users may adapt the application code for their specific purposes without the burden of having to understand details of the underlying hardware platform.

In accordance with several embodiments, the tag reader 104 is configurable based upon one or more aspects of the power source 114 in the environment 100 of the tag reader 104. In some embodiments, for example, the tag reader 104 is configured based upon one or more characteristics of the power (e.g., frequency, voltage or level of regulation) provided by the power source 114.

In one variation, the frequency of the power provided by the power source 114 is utilized to indicate the geographical location of the tag reader 104, and the configuration of the tag reader 104 (e.g., operating frequency and/or tag protocol) are adjusted based upon the geographical location. For example, if the power source 114 provides power at 60 Hz, then the tag reader 104 is configured to operate in the United States, and if the power is provided at 50 Hz, then the tag reader is configured to operate in accordance with European regulations.

In another variation, the tag reader 104 may be configurable to alter its management of the power from the power source 114 based upon a quality of the power. For example, if the power from the power source 114 is regulated direct current power, the tag reader 104 may be configured to disengage a power regulation system on the reader-enabled device 102.

It is contemplated that in some variations a tag reader may write its configuration data (e.g., information about its current configuration) to a tag so as to enable another tag reader to read the tag, obtain the stored configuration data and then reconfigure itself in accordance with the configuration data. In this way, a tag reader may propagate its configuration to other tag readers. As an example, if one tag reader is configured in accordance with its environment (e.g., in accordance with one or more of the techniques disclosed herein), it may write its configuration data to a tag so that other tag readers (e.g., tag readers that may not have the ability to adjust to the environment) are able to become reconfigured in accordance with the operating environment. In yet other variations, a tag reader may broadcast its configuration or a configuration update to other readers via an RFID interface, host interface or via another communication path.

In conclusion, the present invention provides, among other things, a configurable tag reader and a system and method for configuring tag readers. Those skilled in the art will readily recognize that numerous variations and substitutions may be made in the invention, its use and its configuration to achieve substantially the same results as achieved by the embodiments described herein. Moreover, it should be recognized that the each of the numerous configuration adjustments that are disclosed herein may be carried out one at a time or simultaneously in various combinations. Similarly, the embodiments of the tag reader disclosed herein may be configurable in accordance with only one, some or all of the disclosed aspects of the tag reader environment. Accordingly, there is no intention to limit the invention to the disclosed exemplary forms. Many variations, modifications and alternative constructions fall within the scope and spirit of the disclosed invention as expressed in the claims.

What is claimed is:

1. A method for enhancing RFID tag reading performance comprising:
deploying an RFID tag reader into an environment that includes at least one RFID tag;
identifying a characteristic of the environment of the RFID tag reader;
adjusting a configuration of the RFID tag reader based upon the characteristic of the environment;
sending a signal to the at least one RFID tag; and
receiving information from the at least one RFID tag.

2. The method of claim 1, wherein sending the signal to the RFID tag includes using an antenna to send the signal, and wherein identifying the characteristic of the environment includes identifying a characteristic of the antenna, and wherein adjusting the configuration includes adjusting the signal based on the characteristic of an antenna.

3. The method of claim 2, wherein adjusting the signal includes adjusting at least one aspect of the signal, the aspect being selected from the group consisting of power of the signal and frequency of the signal.

4. The method of claim 2, wherein identifying the characteristic of the environment includes identifying a geographic operating region based on the characteristic of the antenna, and wherein adjusting the configuration includes adjusting the signal based on the identified geographic operating region.

5. The method of claim 2, wherein identifying the characteristic of the antenna includes identifying a frequency response of the antenna.

6. The method of claim 2, wherein identifying the characteristic of the antenna includes identifying a mechanical interface with the antenna.

7. The method of claim 6, wherein the mechanical interface of the antenna provides one of a plurality of potential electrical connections, wherein each of the plurality of potential electrical connections is associated with a corresponding one of a plurality of configurations for the RFID tag reader.

8. The method of claim 1, wherein identifying the characteristic of the environment includes identifying a characteristic of a device in which the RFID tag reader is embedded, and wherein adjusting the configuration includes adjusting the configuration of the RFID tag reader based upon the characteristic of the device.

9. The method of claim 8, wherein identifying the characteristic of the device includes sensing the characteristic of the device.

10. The method of claim 8, wherein identifying the characteristic of the device includes receiving a signal from the device, the signal identifying the device.

11. The method of claim 1, wherein identifying the characteristic of the environment includes identifying signal transmission conditions of the environment, wherein sending the signal to the RFID tag includes sending the signal using a channel selected from a table of channels, and wherein adjusting the configuration includes adjusting operation of the RFID tag reader by self-generating the table of channels.

12. The method of claim 1 1, wherein identifying the signal transmission conditions includes identifying signal transmission conditions selected from the group consisting of tag reader reliability, rate, interference levels in the channels and reception range.

13. The method of claim 1, wherein identifying the characteristic of the environment includes identifying a characteristic of radio hardware, and wherein adjusting the configuration includes selecting a radio driver based upon the radio hardware characteristic.

14. The method of claim 1, wherein identifying the characteristic of the environment includes receiving information from other RFID tag readers, and wherein adjusting the configuration includes setting operating parameters of the RFID tag reader based upon the information received from other RFID tag readers.

15. The method of claim 14, wherein setting operating parameters includes setting operating parameters selected from the group consisting of frequency, power, modulation type, antenna selection, reader scanning duty cycle, and tag protocol type.

16. The method of claim 1, wherein identifying the characteristic of the environment includes identifying characteristics of a host interface, wherein adjusting the configuration includes adjusting the configuration of the RFID tag reader based upon the characteristics of the host interface.

17. The method of claim 16, wherein identifying characteristics of the host interface includes identifying characteristics selected from the group consisting of a physical layer protocol of the host interface, a data link protocol for the host interface, a syntax utilized by the host interface and content of transported data.

18. The method of claim 1, wherein identifying the characteristic of the environment includes identifying a characteristic of a power source in the environment of the RFID tag reader, and wherein adjusting the configuration includes adjusting the configuration of the RFID tag reader based upon the characteristic of the power source.

19. The method of claim 18, wherein identifying the characteristic of the power source includes identifying at least one characteristic selected from the group consisting of a frequency of the power source, a voltage of the power source, a regulation characteristic of the power source, and a load capability of the power source.

20. The method of claim 1, wherein the RFID tag reader includes an analog front end.

21. The method of claim 1, wherein the RFID tag reader includes software and a processor configured to execute the software.
